(19) United States
(12) Patent Application Publication
(10) Pub. No.: US 2009/0048943 A1
(43) Pub. Date: Feb. 19, 2009

(54) INTERNET BASED CUSTOMER DRIVEN PURCHASE METHOD AND APPARATUS

(76) Inventor: JOHN W. HARDIGREE, CANTON, GA (US)

Correspondence Address: GARLICK HARRISON & MARKISON, P.O. BOX 160727, AUSTIN, TX, 78716-0727, US

(21) Appl. No.: 12/187,296

(22) Filed: Aug. 6, 2008

Related U.S. Application Data
(60) Provisional application No. 60/956,574, filed on Aug. 17, 2007.

(51) Int. Cl. G06Q 30/00

(52) U.S. Cl. 705/27

(57) ABSTRACT

A system and apparatus for facilitating communication network based purchase transactions includes logic to enable a user to produce a specific purchase offer, tender payment, and to enable sellers to satisfy the purchase offer. The embodiments include a system for receiving a search request, performing a search and offering at least one product for purchase by a user, receiving a user specified product purchase offer and performing a search. If necessary, pooling a plurality of user specified product purchase offers, determining a pooled price for the at least one product presenting an offer to at least one buyer for a pooled quantity at a specified price for the at least one product to facilitate the purchase transaction.

### CROSS-REFERENCE TO RELATED APPLICATIONS

The present U.S. Utility Patent Application claims priority pursuant to 35 U.S.C. §119(e) to U.S. Provisional Patent Application Ser. No. 60/956,574, entitled “Internet Based Customer Driven Purchase Method and Apparatus,” (Attorney Docket No. UGIM001), filed Aug. 17, 2007, which is hereby incorporated herein by reference in its entirety and made part of the present U.S. Utility Patent Application for all purposes.

### BACKGROUND OF THE INVENTION

1. Technical Field of the Invention

This invention relates generally to an apparatus and a method for facilitating user driven purchases of products and services.

2. Description of the Related Art

Heretofore, a user has entered a product description, product name or product number in an Internet sales engine to find sellers of the product to purchase a product over the Internet. Similar searches may also be made for services though the search terms may differ. One noteworthy point, however, is that the sales terms are typically driven by the seller. For example, the seller will dictate the price, shipping times and costs and other material aspects of the transaction. In theory, the buyer then examines the results and chooses the seller thereby allowing supply and demand, in a macro-economic perspective, drive the price of the product down or up according.

One problem with such an approach, however, is that the user is required, sometimes, to extensively review search results to find an acceptable purchase price. Thus, undesirable levels of effort may be required. Further, the market tends to price items based upon the prices of other sellers thereby enabling prices to remain higher than theoretical supply and demand concepts might dictate. Improvements in such processes are therefore desirable from the user's perspective.

### BRIEF SUMMARY OF THE INVENTION

A system and apparatus as claimed herein is operable to support Internet based purchase transactions on terms specified by a user. According to one embodiment of the invention, and method and apparatus facilitate a communication network supported purchase operation that includes a procurement server receiving a search request, performing a search and offering at least one product for purchase by a user, receiving a user specified product purchase offer, receiving and holding payment from the user, supporting a purchase between a seller and the user if user terms and seller terms correspond, and supporting alternate purchase processes in an effort to fulfill the user's purchase offer if the user and seller terms do not correspond.

The method and apparatus further support a manual purchase process that includes placing purchase offers on one of a web page, web service, data transfer, remote portlet, or RSS feed with purchase offer information. Additionally, method and apparatus support purchase and sales bundling or pooling to facilitate purchase transactions between buyers and sellers.

An apparatus, and more particularly, a procurement server, for facilitating a communication network supported purchase operation generally includes an input/output module for generating and processing at least one of audio and visual display signals and data entry signals, respectively, a memory for storing computer instructions and data that define operational logic of the server and a processing module operable to communicate with the input/output module and the memory and further operable to process the computer instructions and data in the memory. Additionally, a communication module is operably coupled to the processing module to enable the procurement server to communicate over wired and wireless communication networks and channels. The procurement server is operable, in one embodiment, receive a search request, perform a search and offer at least one product for purchase by a user, receive a user specified product purchase offer, receive and hold payment from the user, support a purchase between a seller and the user if user terms and seller terms correspond and support alternate purchase processes in an effort to fulfill the user's purchase offer. The procurement server is further operable to support purchase and sales bundling or pooling to facilitate purchase transactions between buyers and sellers. With respect to payment for the service provided by the procurement server as well as the product itself, the procurement server is operable to communicate with a banking institution server to transmit held funds until payment is required and to retrieve such funds to reimburse a user. In one embodiment, the procurement server is operable to reduce the refund by an administrative charge.

Other features and advantages of the present invention will become apparent from the following detailed description of the invention made with reference to the accompanying drawings.

### BRIEF DESCRIPTION OF SEVERAL VIEWS OF THE DRAWINGS

These and other features, aspects and advantages of the present invention will be more fully understood when considered with respect to the following detailed description, appended claims and accompanying drawings wherein:

FIG. 1 is a flow chart illustrating a method for facilitating a purchase transaction according to one embodiment of the invention;

FIG. 2 is a functional block diagram of a system that illustrates one embodiment of the present invention;

FIG. 3 is a functional block diagram of a procurement server for facilitating user driven purchase transactions according to one embodiment of the invention;

FIG. 4 is a flow chart that illustrates a procurement method according to one embodiment of the invention;

FIG. 5 is a flow chart that illustrates a procurement method according to one embodiment of the invention that includes making pooled offers to sellers; and

FIG. 6 is a flow chart that illustrates a procurement method according to one embodiment of the invention that includes auto fulfillment and manual fulfillment according to one embodiment of the invention.

### DETAILED DESCRIPTION OF THE INVENTION

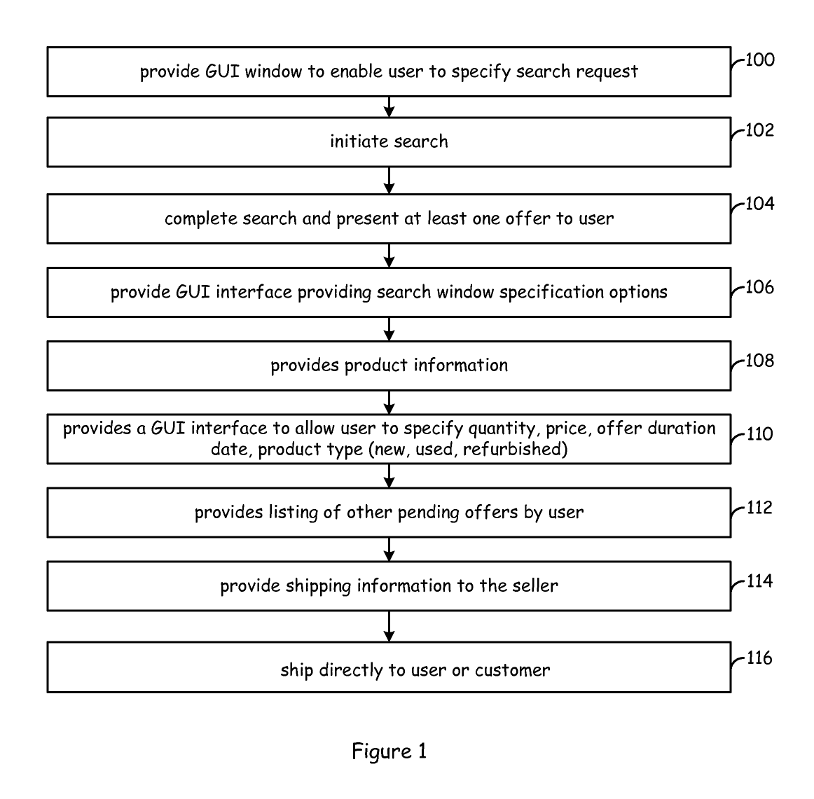

FIG. 1 is a process diagram that illustrates one embodiment of the present invention. As may be seen from FIG. 1, a server provides a graphical user interface (GUI) window to unable a user to specify a search request (100). Thereafter, the server initiates a search (102) which results in a server performing a search and offer (104) and seller fulfillment (108).

As a part of search and offer (104), a server supports search engine operation and, more particularly, the generation of a graphical user interface (GUI) display to facilitate the user performing (specifying search terms and requesting) the search. As a part of performing a search and offer (104), for example, the process includes a server providing GUI interface search window specification options (106), providing product information (108), providing a GUI interface to allow user to specify quantity, price, offer duration date, product type (new, used, refurbished) (110), and providing a listing of other pending offers by user (112). As a part of the seller fulfillment, the server supports providing shipping information to the seller (114) to enable the seller to ship directly to user or customer (116).

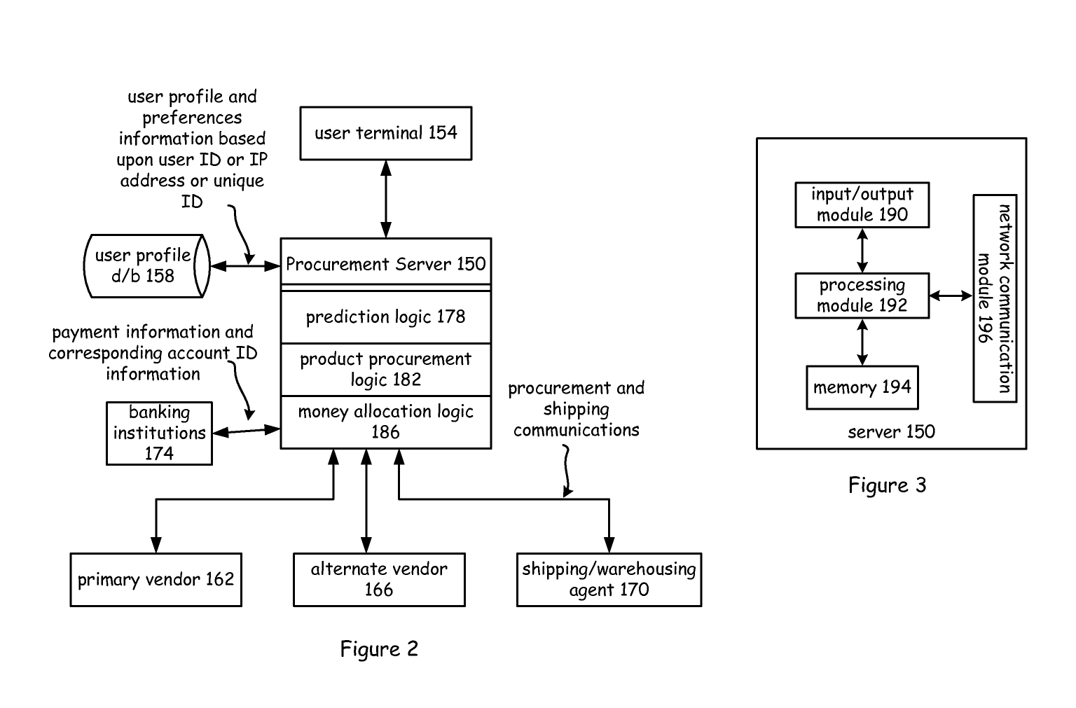

FIG. 2 is a system diagram of a procurement server that operates according to one embodiment of the invention. The procurement server 150 is operable to communicate with a user terminal 154 to receive a search request, or alternatively, with a search engine or advertisement server (Ad server) to receive a specific product request. User terminal 154 connects to procurement server directly by using an entered or stored IP address or equivalent, through search engine, or by web advertising. The product information may also be received from any other type of user interface system such as an interactive voice response (IVR) system that is operable to receive auditory information from the user and to direct the user to auditory responses and directions to obtain user search requirements.

Based on collected search and purchase history for individual users and in aggregate over time, the procurement server is operable to provide personalized product recommendations, advertisements, etc., either online, through email, newsletters, or any other media. Thus, in one embodiment, the procurement server 150 is operable, based upon a customer profile stored in a user profile database 158, to receive a user profile to customize searches and results. In one embodiment, the procurement server 150 is operable to generate user specific catalogs based on the user profile. For example, if a user profile states that only a certain type of product or product supplier is desired (e.g., a so-called “green” supplier or product), then server 150 generates a user specific catalog of only “green” products or suppliers.

The procurement server 150 is further operable to communicate with a primary vendor 162, an alternate vendor 166 and a shipping/warehouse agent 170 to facilitate fulfilling the customer order. The procurement server 150 is further operable to communicate with banking institutions 174 to provide payment information for fulfilled orders and to provide customer payment to hold funds in a holding account until and order is filled. As will be described in greater detail below, one aspect of one embodiment of the invention is that the procurement server 150 charges the user the entered purchase price and holds such funds in escrow until the transaction is completed on the user's terms or is terminated. Accordingly, server 150 is operable to transmit such funds to banking institution 174 to hold such funds.

The procurement server 150 includes prediction logic 178, product procurement logic 182 and money allocation logic 186 in support of the described and claimed functionality. Prediction logic 178 is operable to learn, predict user preferences, and customize on-going offers with user (e.g., user specific catalogs based on user profile). Any known type of heuristic processing or learning logic may be used to process purchase and/or search logic to identify user preferences and to populate the user profile in database 158.

Product procurement logic 182 is operable to support auto fulfillment, seller collaboration, manual procurement interaction, customer collaboration including pooling of orders, shipping and payment. With respect to the pooling of orders, the product procurement logic 182 is operable to search all offers made and not satisfied for a particular product and to pool such offers to make a collected offer to one or more sellers to entice the sellers based upon increase volumes of sales. As such, such pooling will tend to drive down prices of the specified pooled items. Money allocation logic 186 is operable to distribute buyer payment price to selected vendor, procurement server service provider, shipping agent (if different from seller) according to specified logic.

FIG. 3 is a functional block diagram that illustrates operational structure of a procurement server according to one embodiment of the invention. Here, procurement server 150 of FIG. 2 is illustrated. As may be seen, server 150 comprises an input/output module 190 that is operable coupled to processing module 192 which is further coupled to memory 194 and network communication module 196. Input/output module 190 includes circuitry to support generating and processing signals of any known human interface device including display devices, sound devices, data entry devices, etc. Memory 194 stores computer instructions and temporary and permanent data for execution and/or processing by processing module 192. Thus, for example, by executing computer instructions stored in memory 194, logic 178, 182 and 186 may be generated to perform the associated processes. Each of these logics comprises any combination of logic defined by instructions as well as data generated, stored and processed as a part of the defined functionality.

Procurement server 150, as shown in FIGS. 2 and 3 is operable to facilitate a communication network supported purchase operation wherein the processing module communicates with the input/output module and the memory and further operable to process the computer instructions and data in the memory to operate according to the logic defined by computer instructions stored within the memory. Thus, the procurement server 150, by communicating with external devices and networks through the communication module 196 is operable to receive a search request, perform a search and offer at least one product for purchase by a user. This includes receiving a user specified product purchase offer, receive and hold payment from the user before the transaction is consummated and even before a seller is found in one embodiment of the invention. The procurement server 150 is further operable to support a purchase between a seller and the user if user terms and seller terms correspond and to support alternate purchase processes in an effort to fulfill the user's purchase offer. This includes the procurement server bundling or pooling purchases to facilitate purchase transactions between buyers and sellers. In one embodiment, procurement server 150 produces pooled purchase offers to at least one seller to attempt to fulfill the purchase requests. In one embodiment, server 150 publishes a net purchase price on a specified web page to enable sellers to periodically review outstanding purchase offers. In one embodiment, the published net price is published as a part of a bundled transaction to facilitate purchase order fulfillment for a plurality of purchasers and a larger sales transaction by a user.

The procurement server 150 further communicates with a banking institution to generate a refund of the user's purchase price if a purchase transaction is not fulfilled. In one embodiment, the procurement server 150 reduces the refund by an administrative charge amount. The offers generated by procurement server 150 include at least one of a purchase price and a delivery deadline. Based on search results or responses to purchase offers, procurement server 150 determines if the purchase offer may be filled by evaluating a seller price, a shipping price and the purchase price.

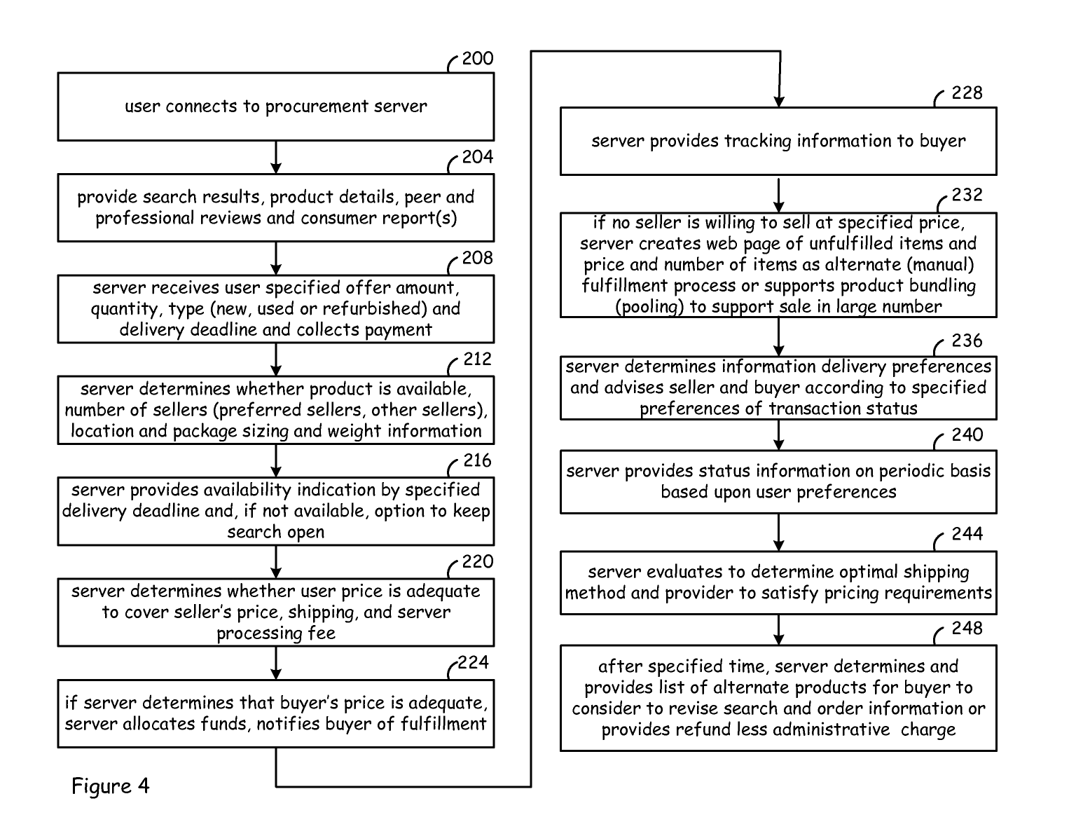

FIG. 4 is a flow chart that illustrates operation according to one embodiment of the invention. Each of these process steps in FIG. 4, as well as the subsequent flow charts, is a process step that may be performed by procurement server 150. The method of FIG. 4, for example, may be performed by procurements server 150 of the system of FIGS. 2 and 3. The method begins with the user connecting to the procurement server by way of one or more communication networks (step 200). These communication networks include wireless, wired and fiber optic networks. The server is thereafter operable to provide search results, product details, peer and professional reviews and consumer report(s) (step 204). Thus, the server receives user specified offer amount, quantity, type (new, used or refurbished) and delivery deadline and collects payment (step 208).

Thereafter, the server determines whether a desired product is available, a number of sellers (preferred sellers, other sellers), location and package sizing and weight information (step 212). Based upon this determination of step 212, the procurement server provides availability indication by specified delivery deadline and, if not available, option to keep search open (step 216). The server subsequently determines whether user price is adequate to cover seller's price, shipping, and server processing fee (step 220). If the server determines that buyer's price is adequate, server allocates funds, notifies buyer of fulfillment (step 224), the server provides tracking information to buyer (step 228).

If no seller is willing to sell at specified price, the server creates web page of unfulfilled items and price and number of items as alternate (manual) fulfillment process or supports product bundling (pooling) to support sale in large number (step 232). The server also determines information delivery preferences and advises seller and buyer according to specified preferences of transaction status (step 236). Moreover, the server provides status information on periodic basis based upon user preferences (step 240). The server is also operable to determine an optimal shipping method and optimal provider to satisfy pricing requirements (step 244). After specified time, the procurement server determines and provides list of alternate products for buyer to consider revising search and ordering information or provides a refund less administrative charge (step 248).

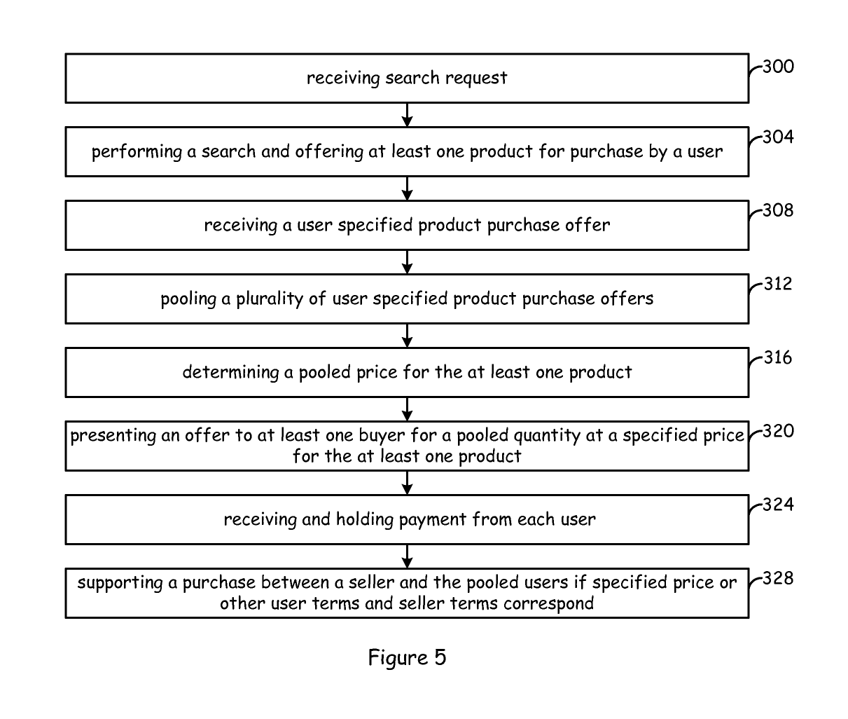

A method for facilitating a communication network supported purchase operation is also shown in FIG. 5. The method of FIG. 5 comprises receiving a search request (step 300), performing a search and offering at least one product for purchase by a user (step 304), receiving a user specified product purchase offer (step 308), and pooling a plurality of user specified product purchase offers (step 312). The step of pooling the plurality of users includes determining what uses have unsatisfied purchase offers.

Thereafter, the method includes determining a pooled price for the at least one product (step 316) and presenting an offer to at least one buyer for a pooled quantity at a specified price for the at least one product (step 320). The above steps further include receiving and holding payment from each user (step 324). Thereafter, if a seller accepts the pooled purchase offers, the method includes supporting a purchase between a seller and the pooled users if specified price or other user terms and seller terms correspond (step 328).

Operation according to one embodiment of the invention may be better understood with the following user case study example.

Case Study:

David wishes to search online for a camera his wife wants or a product category of “high-end digital cameras”. David is linked to an application server system through a search engine or direct; where he is able to research price, product details (specs, warranty, etc), peer reviews and potentially a consumer reports section. The application server is one that specifically supports the services of the embodiments of the present invention.

David decides he would like a specific camera and registers a contract offer of $1450 and specifies that he wants the product by the end of the next day. David receives a notification sent by the application server system in 5 minutes or less via his preferred alerting method (email, SMS, phone) that this offer has been accepted and will be delivered by 3pm the next day. The preferred alerting method is one that he specifies along with his contract offer or one that is specified in a user profile. If the product is not immediately available, he is notified that his deadline cannot be met and the application server system can keep this offer open if he chooses to do so or refund his offer—minus the $1 posting/administration fee and any credit charges.

During these few minutes a third party Fulfillment Information Network (FIN) is identifying whether the inventory exists, if so, whether the product can be delivered by the deadline and whether the offer will cover the seller's price and shipping cost. FIN completes the following fulfillment tasks:

1. Inventory is identified with an “exclusive seller” (where we know their inventory levels and they have first right of refusal), 5 large (Retail) sellers, and 10 wholesale sellers.

2. The Fulfillment Optimization process identifies the least costly method for picking packing and shipping while ensuring delivery by deadline (From warehouse for a specified price (e.g., $9.50).

3. Pricing model is calculated as follows:
Buyer offer of $1450 minus 4% (exemplary application server system service charge)=$1392.
Offer to fulfill is $1392 minus (the seller's price is $1300) minus (FIN Determines Shipping Price of $9.50)=($82.50 additional revenue for application server system company).

3. As this pricing scenario is covered by the $1392 Buyer's payment—an alert is issued to the buyer including a tracking number and expected time of arrival.

4. The product is picked up and shipped by primary warehousing provider or other seller.

5. The Inventory System is updated to reflect the reduction of product.

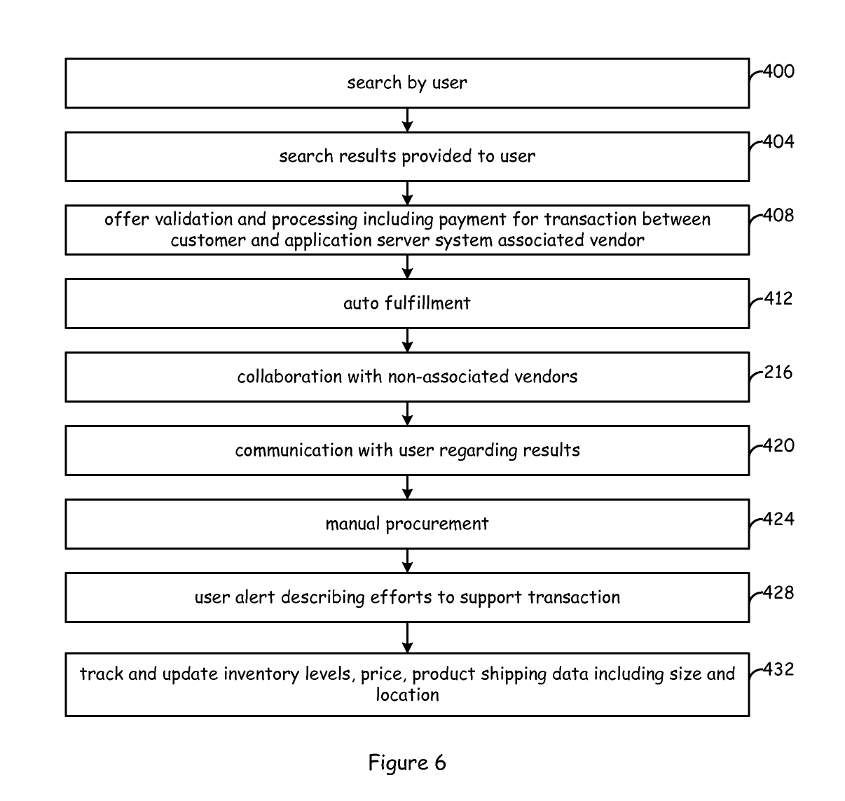

The above case study may also be viewed in relation to FIG. 6. FIG. 6 is a process flow diagram. In the first step (step 400), the customer begins a search for a specific item. In the second step, (step 404), the application server system facilitates information about the product and the offer (quantity, price, duration and type). In the third step, (step 408) the application server system validates the offer and processes payment.

In steps 400-408, the application server system operably communicates with the customer (user) by way of the Internet, voice and/or data cellular networks, LAN and WLAN connections, or the public switched telephone network (PSTN). An application server system is further operable to provide an applet for installation on the customer equipment to facilitate or support the described interactions and capabilities. Such capabilities include, for example, profiling capabilities, learning of user preferences and likely preferences.

In a fourth step, (step 412), auto fulfillment occurs wherein the application server system determines whether inventory exists (with associated vendors), whether the customer offer price is sufficiently high to cover service charges including shipping. If the customer offer price is not sufficiently high or if there is no inventory with the associated vendors, the application server engages in the next step (step 416) collaborates with non-associated vendors to determine if the customer requirements (offer) can be satisfied. If a seller can be found for which the customer offer is sufficient, the application server system determines the optimal shipping method and communicates the same to the customer in a new step (step 420). If not, a manual procurement step (step 424) is performed in which a professional salesperson to assist in the purchase transaction. The salesperson may also be one that works with sellers to find buyers. The salesperson is given access to the application server system as necessary. In addition to steps 416-420, the application server system also is operable to alert the customer (step 428) at a specified periodic rate to describe efforts to find the product for purchase at the offer price. These alerts can also include substitute options.

For each of the steps 412-428, data that tracks inventory levels, price, product shipping data including size and location, is stored and updated in a memory. Further, the application server system is operable to post offers on a specified web site (open or secure) to facilitate transactions with sellers.

The invention disclosed herein is susceptible to various modifications and alternative forms. Specific embodiments therefore have been shown by way of example in the drawings and detailed description. It should be understood, however, that the drawings and detailed description thereto are not intended to limit the invention to the particular form disclosed, but on the contrary, the invention is to cover all modifications, equivalents and alternatives falling within the spirit and scope of the present invention as defined by the claims.

What is claimed is:

1. A method for facilitating a communication network supported purchase operation, comprising:
receiving a search request;
performing a search and offering at least one product for purchase by a user;
receiving a user specified product purchase offer;
receiving and holding payment from the user;
supporting a purchase between a seller and the user if user terms and seller terms correspond;
supporting alternate purchase processes in an effort to fulfill the user's purchase offer.

2. The method of claim 1 further including supporting a manual purchase process that includes placing purchase offers on one of a web page, web service, data transfer, remote portlet, or RSS feed with purchase offer information.

3. The method of claim 1 further including supporting purchase and sales bundling or pooling to facilitate purchase transactions between buyers and sellers.

4. The method of claim 1 further including refunding the user's purchase price if a purchase transaction is not fulfilled.

5. The method of claim 4 further including reducing the refund by an administrative charge.

6. The method of claim 1 wherein the purchase offer includes at least one of a purchase price and a delivery deadline.

7. The method of claim 6 further including determining if the purchase offer may be filled by evaluating a seller price, a shipping price and the purchase price.

8. The method of claim 7 further including determining a net purchase price after shipping and server transaction prices are deducted and publishing the net purchase price to facilitate a purchase transaction.

9. The method of claim 8 wherein the net purchase price is published on a specified web page.

10. The method of claim 9 wherein the published net price is published as a part of a bundled transaction to facilitate purchase order fulfillment for a plurality of purchasers and a larger sales transaction by a user.

11. A method for facilitating a communication network supported purchase operation, comprising:
receiving a search request;
performing a search and offering at least one product for purchase by a user;
receiving a user specified product purchase offer;
pooling a plurality of user specified product purchase offers;
determining a pooled price for the at least one product; and
presenting an offer to at least one buyer for a pooled quantity at a specified price for the at least one product.

12. The method of claim 11 further including receiving and holding payment from each user.

13. The method of claim 11 further including supporting a purchase between a seller and the pooled users if specified price or other user terms and seller terms correspond.

14. A procurement server for facilitating a communication network supported purchase operation, comprising:
an input/output module for generating and processing at least one of audio and visual display signals and data entry signals, respectively;
a memory for storing computer instructions and data that define operational logic of the server;
a processing module operable to communicate with the input/output module and the memory and further operable to process the computer instructions and data in the memory;
a communication module operably coupled to the processing module; and
wherein the procurement server is operable to:
receive a search request;
perform a search and offer at least one product for purchase by a user;
receive a user specified product purchase offer;
receive and hold payment from the user;
support a purchase between a seller and the user if user terms and seller terms correspond; and
support alternate purchase processes in an effort to fulfill the user's purchase offer.

15. The procurement server of claim 14 wherein the procurement server is further operable to support purchase and sales bundling or pooling to facilitate purchase transactions between buyers and sellers.

16. The procurement server of claim 14 wherein the procurement server is further operable to communicate with a banking institution to generate a refund of the user's purchase price if a purchase transaction is not fulfilled.

17. The procurement server of claim 16 wherein the refund is reduced the refund by an administrative charge.

18. The procurement server of claim 14 wherein the purchase offer includes at least one of a purchase price and a delivery deadline.

19. The procurement server of claim 14 wherein the procurement server is operable to determine if the purchase offer may be filled by evaluating a seller price, a shipping price and the purchase price.

20. The procurement server of claim 14 wherein the procurement server is operable to publish the net purchase price on a specified web page.

21. The procurement server of claim 20 wherein the published net price is published as a part of a bundled transaction to facilitate purchase order fulfillment for a plurality of purchasers and a larger sales transaction by a user.
